(19) United States
(12) Patent Application Publication
(10) Pub. No.: US 2010/0194507 A1
(43) Pub. Date: Aug. 5, 2010

(54) Method for the Production of Magnet Cores, Magnet Core and Inductive Component with a Magnet Core

(75) Inventor: Markus Brunner, Bessenbach (DE)

Correspondence Address: BUCHANAN, INGERSOLL & ROONEY PC, POST OFFICE BOX 1404, ALEXANDRIA, VA, 22313-1404, US

(73) Assignee: Vacuumschmeize GmbH & Co. KG, Hanau (DE)

(21) Appl. No.: 12/670,119

(22) PCT Filed: Jul. 23, 2008
(86) PCT No.: PCT/IB2008/052948

§ 371 Date: Jan. 21, 2010

(30) Foreign Application Priority Data
Jul. 24, 2007 (DE) 10 2007 034 925

(51) Int. Cl. H01F 3/00; B22F 3/12; B22F 1/00; B22F 1/02

(52) U.S. Cl. 335/297; 419/38; 419/30; 419/35; 419/29

(57) ABSTRACT

A magnet core (1) made of a composite of platelet-shaped particles of a thickness D and a binder has a particularly linear relative permeability curve over a pre-magnetised constant field. For this purpose, the platelet-shaped particles (5) are provided with an amorphous volume matrix (8), wherein areas (9) with a crystalline structure having a thickness d of 0.04*D≦d≦0.25*D and covering a proportion x of x≧0.1 of the surface (6, 7) of the particle (5) are embedded on the surface (6, 7) of the particle (5).

### BACKGROUND

1. Field

Disclosed herein is a method for the production of magnetic powder composite cores pressed from a mix of alloy powder and binder. Also disclosed herein is a magnet core produced from a mix of alloy powder and binder and to an inductive component with a magnet core of this type.

2. Description of Related Art

Magnet cores, which are for example used in switched power supplies as storage chokes or as choke cores on the system input side, have to have a low permeability which must not be changed significantly either by a varying AC modulation or by a constant magnetic field superimposed on the AC modulation. For such applications, ferrite cores with an air gap have proved useful for the currently preferred operating frequencies in the range of some ten to a hundred kHz, while magnetic powder composite cores are used for higher-rated equipment.

Depending on operating frequency, the required storage energy and available space, various alloys can be considered for the production of these metal powder composite cores. In the simplest case, pure iron powders are used, but if superior magnetic properties are required, FeAlSi-based crystalline alloys (SENDUST) or even NiFe-based alloys are preferred. The most recent developments favour the use of rapidly solidified amorphous or nanocrystalline iron-based alloys. Amorphous FeSiB-based alloys, in particular, appear to offer advantages compared to classical crystalline alloys owing to their high saturation inductance, their low particle thickness due to manufacturing methods, and their high resistivity. Apart from the alloy itself, other factors such as a high packing density of the powder composite core are also highly relevant if the magnet core is to have a high storage energy or a high DC pre-loadability.

U.S. Pat. No. 7,172,660 B2 discloses powder composite cores produced from a rapidly solidified amorphous iron-based alloy, wherein a particularly high packing density of the magnet core is obtained by using a powder with a bimodal particle size distribution. The use of rapidly solidified amorphous alloys rather than crystalline alloys poses the problem that pressing at moderate temperatures does not result in a viscous flow of the powder particles, so that higher packing densities are difficult to obtain.

According to U.S. Pat. No. 5,509,975 A, high packing densities can also be obtained by pressing the powder to form a magnet core at temperatures slightly below the crystallisation temperature of the alloy used. However, the magnet cores produced in this way have a relatively high relative permeability and are therefore not suitable for applications where a maximum storage energy is required.

In addition, the relative permeability of these magnet cores changes significantly, in particular in the range of low modulations with constant magnetic fields. This is due to the marked platelet shape of the powder particles produced by the comminution of rapidly solidified strip. As a result, the powder particles are in the pressing process oriented with their face normal in the pressing direction, and the starting permeability becomes extremely high, particular at a high packing density, followed by a marked reduction in relative permeability as constant magnetic field modulation increases. This effect is described analytically in F. Mazaleyrat et al.: “Permeability of soft magnetic composites from flakes of nano crystalline ribbon”, IEEE Transactions on Magnetics Vol. 38, 2002. This behaviour is undesirable in magnet cores used as storage chokes or as chokes for power factor correction (PFC chokes) in pulsed power supplies.

### SUMMARY

There remains a need to solve the problem of specifying a magnet core, which in certain embodiments is desirably made from a powder of a rapidly solidified, amorphous iron-based alloy, which has both a high packing density and a highly linear permeability curve above a pre-magnetised constant field.

According to certain embodiments described herein, this problem is solved by the magnet cores, inductive components and methods of making these described herein.

In a particular embodiment is disclosed a magnet core comprising a composite of platelet-shaped powder particles with the thickness D and a binder, wherein the particles have an amorphous volume matrix. In this amorphous volume matrix are, on the surface of the particles, embedded areas with a crystalline structure which have a thickness d of 0.04*D≦d≦0.25*D, preferably 0.08*D≦d≦0.2*D, and cover a proportion x of x≧0.1 of the surface of the particles. The symbol “*” denotes multiplication.

As a result, the generally amorphous particles have on their surfaces crystallised-on regions which do not necessarily form a continuous layer. As, described herein, this crystallisation can be obtained by a heat treatment of the magnet core after pressing, wherein the crystals grow from the surface of the particles into the amorphous volume matrix.

While not wishing to be based by any theory, it is believed that, the storage energy of a magnet core can be increased further by providing that the surfaces of the individual particles are partially crystallised by means of a special heat treatment as disclosed herein. The surface crystallisation involves a volume shrinkage in the region of the surface, which induces tensile stresses in the surface layer while inducing compressive stresses in the amorphous volume matrix of the particles. In combination with the high positive magnetostriction of FeSiB-based alloys, the compressive stresses in the volume matrix result in a magnetic preferred direction towards the face normal of the platelet-shaped particles. When the powder is pressed, the powder platelets align themselves under compacting pressure such that the platelet plane lies at right angles to the pressing direction and therefore parallel to the subsequent magnetisation direction of the magnet core. As a result, the anisotropy caused by the stress-induced magnetic preferred direction leads to a magnetic preferred direction of the magnet core at right angles to its magnetisation direction. The result is a linearisation of the modulation-dependent permeability curve of the magnet core which exceeds the influence of the geometrical shear of the magnetic circuit via the air gaps between the individual particles.

### BRIEF DESCRIPTION OF DRAWINGS

Embodiments disclosed herein are explained in greater detail below with reference to the accompanying figures, which are not intended to be limiting.

FIG. 1 is a schematic diagram of an embodiment of a magnet core described herein;

FIG. 2 is a schematic diagram showing the detailed structure of a magnet core made of platelet-shaped particles as described herein;

FIG. 3 is a schematic diagram showing a cross-section through a section of an individual platelet-shaped particle;

FIG. 4 is a schematic diagram showing a cross-section through a section of an individual platelet-shaped particle;

FIG. 5 is a graph showing the DC superposition permeability curve of magnet cores according to an embodiment described herein; and

FIG. 6 is a graph showing the DC preloadability curve B₀ for magnet cores according to FIG. 5.

Identical components are identified by the same reference numbers in all figures.

### DETAILED DESCRIPTION OF SPECIFIC EMBODIMENTS

G. Herzer et al.: “Surface crystallisation in metallic glasses”, Journal of Magnetism and Magnetic Materials 62 (1986), 143-151, suggests that, in soft magnetic strip, a crystallising-on of the strip surfaces can lead to a magnetic anisotropy of the material. However, it has surprisingly been found that this effect can also be used in the production of powder composite cores. While it has up to now been thought that the influence of geometrical shear via the air gap predominates in powder composite cores, it was established that the surface crystallisation of the platelet-shaped particles in the magnet cores as described herein results, against all expectations, in a further linearisation of the modulation-dependent permeability curve and thus to an unexpectedly improved suitability of the magnet cores for use as choke cores.

The term “platelet-shaped” in the present context describes particles which, for example as a result of being produced from strip or pieces of strip, essentially have two parallel main surfaces opposing each other, and which have a thickness significantly less than their length dimension in the plane of the main surfaces. The platelet-shaped particles advantageously have an aspect ratio of at least 2. In one embodiment, the thickness D of the particles is 10 μm≦D≦50 μm, preferably 20 μm≦D≦25 μm. In contrast, the average particle diameter L in the plane of the main surfaces is preferably approximately 90 μm.

In an advantageous embodiment, the alloy composition of the particles is M_{α}Y_{β}Z_{γ}, wherein M is at least one element from the group including Fe, Ni and Co, wherein Y is at least one element from the group including B, C and P, wherein Z is at least one element from the group including Si, Al and Ge, and wherein α, β and γ are specified in atomic percent and meet the following conditions: 60≦α≦85; 5≦β≦20; 0≦γ≦20. In particular embodiments, up to 10 atomic percent of the M component may be replaced by at least one element from the group including Ti, V, Cr, Mn, Cu, Zr, Nb, Mo, Ta and W and up to 10 atomic percent of the (Y+Z) component may be replaced by at least one element from the group including In, Sn, Sb and Pb.

In a particular embodiment, the platelet-shaped particles are advantageously provided with an electrically insulating coating on their surfaces to reduce eddy currents.

In a particular embodiment, as a binder for the powder composite core, at least one material from the group including polyimides, phenolic resins, silicone resins and aqueous solutions of alkali or alkaline earth silicates is used.

At a DC superposition permeability Δμ of 80% of the starting superposition permeability of Δμ₀, a DC preloadability B₀ of B₀≧0.24 T can be obtained with embodiments of the magnet core described herein. The magnet core described herein therefore has excellent storage properties. As a result, it can be used to advantage in an inductive component. Owing to its magnetic properties, it is particularly suitable for use as a choke for power factor correction, as a storage choke, as a filter choke or as a smoothing choke.

In an embodiment of a method described herein for the production of a magnet core is included at least the following steps: A powder of amorphous, platelet-shaped particles with the thickness D is prepared and pressed with a binder to produce a magnet core. The magnet core is then heat treated for a duration tₐₙₙₑₐₗ≧5 h at a temperature Tₐₙₙₑₐₗ of 390° C.≦Tₐₙₙₑₐₗ≦440° C. while areas with a crystalline structure embedded in the amorphous volume matrix are formed on the surface of the particles.

In an advantageous embodiment, heat treatment is continued until the areas with the crystalline structure have reached a thickness d of 0.04*D≦d≦0.25*D in the volume matrix and cover a proportion x of the surface of the particles wherein x≧0.1.

In particular embodiments, an alloy of the composition M_{α}Y_{β}Z_{γ} is advantageously used for the particles, wherein M is at least one element from the group including Fe, Ni and Co, wherein Y is at least one element from the group including B, C and P, wherein Z is at least one element from the group including Si, Al and Ge, and wherein α, β and γ are specified in atomic percent and meet the following conditions: 60≦α≦85; 5≦β≦20; 0≦γ≦20, wherein up to 10 atomic percent of the M component may be replaced by at least one element from the group including Ti, V, Cr, Mn, Cu, Zr, Nb, Mo, Ta and W and up to 10 atomic percent of the (Y+Z) component may be replaced by at least one element from the group including In, Sn, Sb and Pb.

In one embodiment of the method, the powder is prepared from amorphous particles in the following process steps: An amorphous strip with a thickness D of 10 μm≦D≦50 μm, preferably 20 μm≦D≦25, μm is produced in a rapid solidification process. The amorphous strip is then pre-embrittled by heat treatment at a temperature T_{embrittle}, followed by the comminution of the strip to produce platelet-shaped particles.

The temperature T_{embrittle} is advantageously 100° C.≦T_{embrittle}≦400° C., preferably 200° C.≦T_{embrittle}≦400° C.

In one embodiment of the method, the amorphous strip is comminuted at a grinding temperature Tₘᵢₗₗ of −196° C.≦Tₘᵢₗₗ≦100° C.

In one embodiment of the method, the particles are pickled in an aqueous or alcoholic solution and then dried before pressing in order to apply an electrically insulating coating.

In certain embodiments, as a binder, at least one material from the group including polyimides, phenolic resins, silicone resins and aqueous solutions of alkali or alkaline earth silicates, is advantageously used. The particles may be coated with the binder before pressing, or the binder may be mixed with the powder before pressing.

The powder is pressed in a suitable tool, for example in certain embodiments at a pressure between 1.5 and 3 GPa. After pressing, in certain embodiments the magnet core may be heat treated for stress relaxation for a duration tᵣₑₗₐₓ of approximately one hour at a temperature Tᵣₑₗₐₓ of approximately 400° C., but this stress relaxation may alternatively be carried out during the heat treatment for surface crystallisation as described herein, so that there is no need for a separate heat treatment for stress relaxation. The heat treatments are advantageously carried out in an inert atmosphere.

In one embodiment of the method, processing additives such as lubricants are added to the particles and to the binder before pressing.

With the method described herein, magnet cores with a modification-dependent permeability curve which is more linear than previously known can be produced by relatively simple means.

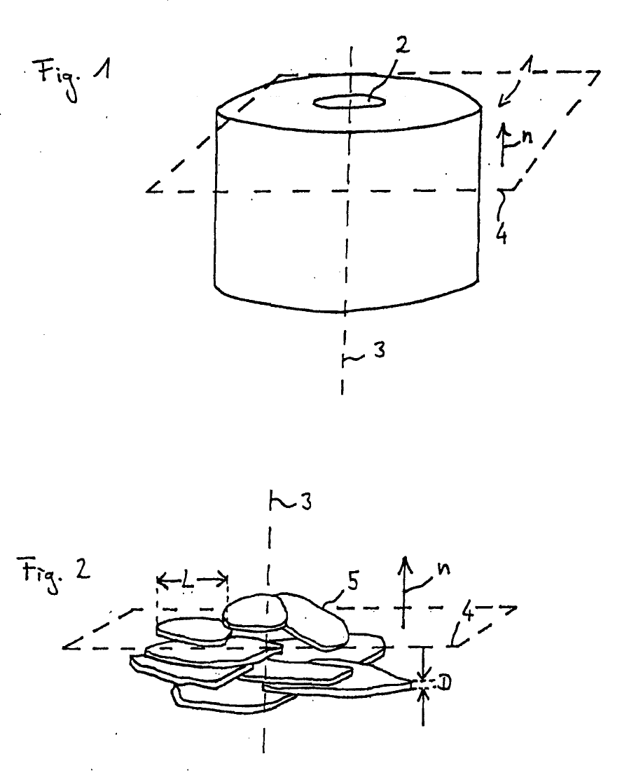

The magnet core 1 according to FIG. 1 is a powder composite core with magnetic properties which permit its use, for example in switched power supplies, as storage chokes or as choke cores on the system input side. The cylindrical magnet core 1 is designed as a toroidal core with a central hole 2 and is symmetrical with respect to its longitudinal axis 3. While the powder is pressed to form the magnet core 1, a force is applied in the direction of the longitudinal axis 3. The plane 4 identified by the normal vector n marks the plane of the direction of magnetisation in the use of the magnet core 1.

FIG. 2 schematically shows the platelet-shaped particles 5 of the magnet core 1 and their arrangement after pressing. The platelet-shaped particles 5 have two parallel main surfaces spaced from each other by the thickness D of the platelet-shaped particles 5. In certain embodiments, these main surfaces originally were the surfaces of a strip produced in a rapid solidification process, which was comminuted to produce the platelet-shaped particles 5. In a particular embodiment, the platelet-shaped particles 5 have an average platelet diameter of approximately 90 μm, which in the present context denotes the diameter L of the platelets in the plane of their main surfaces.

As a result of pressing with a pressure acting in the direction of the longitudinal axis 3, the platelet-shaped particles 5 are oriented substantially parallel to one another, as can be seen in FIG. 2, their main surfaces being parallel to the plane 4 of the magnetisation direction of the magnet core 1.

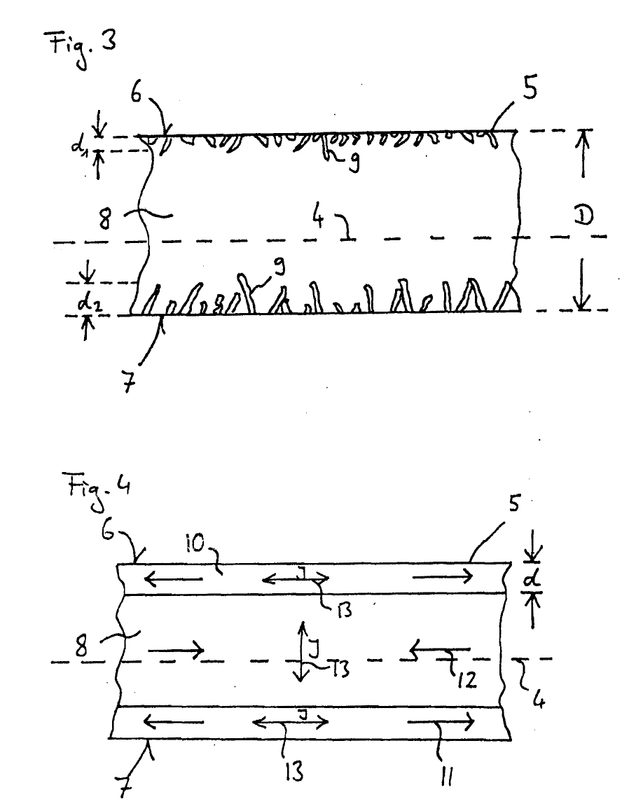

FIG. 3 is a schematic cross-section through a platelet-shaped particle 5. The platelet-shaped particle 5 has a first main surface 6, a second main surface 7 and a volume matrix 8 with an amorphous structure. Areas 9 with a crystalline structure are embedded within the amorphous volume matrix 8. The areas 9 with the crystalline structure are grown into the volume matrix 8 from the first main surface 6 and from the second main surface 7 by means of a heat treatment disclosed herein.

The areas 9 near the first main surface 6 have a thickness d₁, and the areas 7 near the second main surface 7 have a thickness d₂. In the particular embodiment shown in FIG. 3, d₂ is greater than d₁. This is due to the fact that the platelet-shaped particle 5 has been produced by comminuting a strip produced in a rapid solidification process, wherein the second main surface 7 corresponds to the side of the strip facing the rotating wheel. As a result, the material of the strip was subjected to different temperature gradients on its two main surfaces. This relationship is described in G. Herzer et al.: “Surface crystallisation in metallic glasses”, Journal of Magnetism and Magnetic Materials 62 (1986), 143-151.

The relation d₂≠d₁ does not necessarily apply to every embodiment of the magnet core 1 described herein. The essential aspect is that the crystalline areas 9 have an average thickness d (which could be the mean value from d₂ and d₁ in the described embodiment) of at least 5% and at most a quarter of the thickness D of the platelet-shaped particle 5. The crystalline areas 9 cover a proportion x of at least one tenth of the surfaces of the particle 5, i.e. essentially one tenth of the first main surface 6 and the second main surface 7.

In this case, it is believed that the volume shrinkage at the surfaces of the platelet-shaped particles 5, which accompanies crystallisation, causes tensile stresses near the surface and compressive stresses in the volume matrix 8 of the platelet-shaped particles 5. This is illustrated schematically in FIG. 4. The platelet-shaped particle 5 can be divided into the near-surface crystallisation zones 10 with the thickness d and the amorphous volume matrix 8. Volume shrinkage and thus tensile stresses occur in the crystallisation zones 10, where the tensile stresses are indicated by arrows 11. The volume matrix, on the other hand, is subject to compressive stresses indicated by arrows 12.

According to a theory explained by Ok et al. in Physical Review Letters B, 23 (1981) 2257, this results in the crystallisation zones 10 having a magnetic anisotropy J parallel to the plane 4 of the subsequent magnetisation direction and in the volume matrix 8 in a magnetic anisotropy J at right angles to the subsequent magnetisation direction as indicated by arrows 13.

As the volume of the amorphous volume matrix 8 is significantly larger than that of the crystalline areas 9 as a rule, the influence of the anisotropy J at right angles to the plane 4 of the subsequent magnetisation direction predominates, and the parallel orientation of the platelet-shaped particles 5 during the pressing process results in a magnetic preferred direction at right angles to the magnetisation direction of the magnet core 1 and thus in a linearisation of the modulation-dependent permeability curve of the magnet core which exceeds the influence of the geometrical shear of the magnetic circuit.

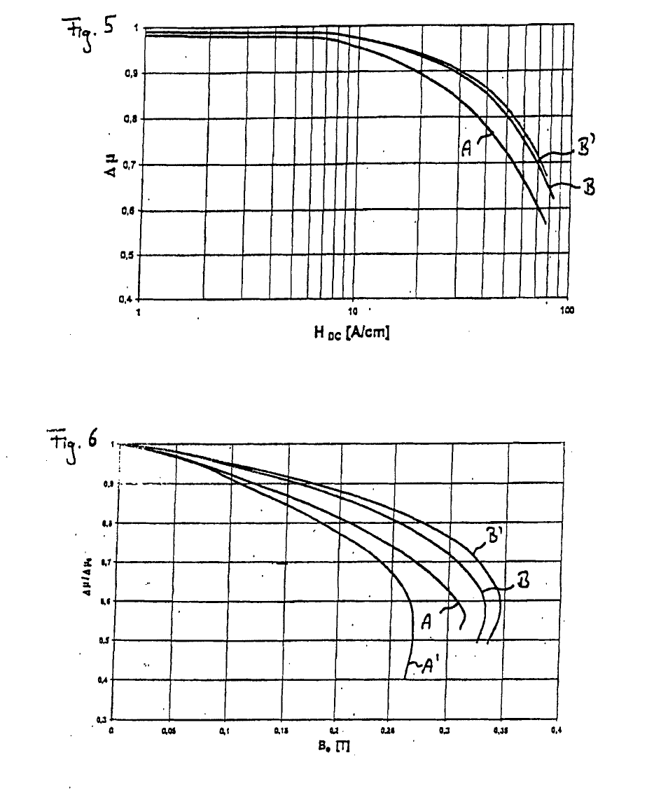

FIGS. 5 and 6 are graphs that show the results of measurements of magnetic variables in one embodiment of magnet cores produced as described herein.

For this purpose, an amorphous strip with a thickness of 23 μm is produced in a rapid solidification process from an alloy of the composition Fe_{Rest}Si₉B₁₂. To reduce its ductility and therefore to make it easier to comminute, this strip is subjected to a heat treatment lasting between half an hour and four hours in an inert atmosphere at a temperature between 250° C. and 350° C. The duration and the temperature of the heat treatment were determined by the required degree of embrittlement; typical values are a temperature of 320° C. and a duration of one hour.

Following the heat treatment for embrittlement, the strip is comminuted using a suitable mill such as an impact mill or disc mill to produce a powder of platelet-shaped particles with an average grain size of 90 μm. The platelet-shaped particles are then provided with an electrically insulating oxalic or phosphate surface coating and coated with a heat-resistant binder selected from the group including polyimides, phenolic resins, silicone resins and aqueous solutions of alkali or alkaline earth silicates. The thus coated platelet-shaped particles are finally mixed with a high-pressure lubricant, which may for example be based on metallic soaps or suitable solid lubricants such as MoS₂ or BN.

The mixture prepared in this way is pressed in a pressing tool at pressures between 1.5 and 3 GPs to form a magnet core. The pressing process is followed by a final heat treatment for stress relaxation and for the formation of crystalline areas on the surface of the platelet-shaped particles, the heat treatment being performed in an inert atmosphere at a temperature between 390° C. and 440° C. for a duration of 5 to 64 hours.

FIG. 5 shows the effect of surface crystallisation of the platelet-shaped particles on the DC superposition permeability curve Δμ. The magnet core of curve A was produced in the manner described above, but the heat treatment for the surface crystallisation of the platelet-shaped articles was omitted and the magnet core was only subjected to one hour's heat treatment at 440° C. for stress relaxation. This magnet core A therefore corresponds to magnet cores produced by prior art techniques.

The magnet core of curve B was produced in accordance with the method described herein and heat-treated for 8 hours at 440° C. This magnet core therefore has crystallised areas on the particle surface. The magnet core of curve B′ was likewise produced in accordance with the method described herein and heat-treated for 24 hours at 410° C. This longer heat treatment of the magnet core B′ at a slightly lower temperature results in the compaction of the crystalline surface layer, i.e. the proportion x increases without any significant increase in the thickness d of the crystalline areas. As FIG. 5 shows, this leads to a further linearisation of the DC superposition permeability curve Δμ. All of the magnet cores tested have a starting superposition permeability Δμ₀ of approximately 60.

According to R Boll, “Weichmagnetische Werkstoffe” (Soft-magnetic Materials) (4^{th} edition 1990), pages 114-115, the DC preloadability B₀ defined as B₀=Δμ*μ₀*H_{DC}, wherein Δμ is the DC superposition permeability of the magnet core, μ₀ is the magnetic field constant and H_{DC} is the DC field modification, is a suitable measure for the obtainable storage energy. The DC preloadability B₀ is particularly suitable for the direct comparison of the suitability of various materials for use in choke cores.

FIG. 6 shows the increase of the DC preloadability B₀ for given relative DC superposition permeability values of the magnet cores which can be achieved with the production method according to the invention. For easier comparison, the curve A′ was added for a magnet core made of a known FeAlSi alloy (Sendust). As FIG. 6 shows, the magnet cores according to the invention can achieve a DC preloadability B₀ of B₀≧0.24 T at a DC superposition permeability Δμ of 80% of the starting super-position permeability of Δμ₀.

The invention having been described with reference to certain specific embodiments and examples, it will be seen that these do not limit the scope of the appended claims.

1. A magnet core comprising a composite of:
(a) platelet-shaped particles of a magnetic alloy, each comprising an amorphous volume matrix and two opposing main surfaces which are separated by a thickness D, wherein extending into the amorphous volume matrix from at least one of the surfaces are embedded areas having a crystalline structure, which embedded areas extend into the amorphous volume matrix a thickness d, such that 0.04*D≦d≦0.25*D and which embedded areas cover a proportion x of the surface of the platelet-shaped particles such that x≧0.1; and
(b) a binder.

2. The magnet core according to claim 1,
wherein the thickness d is such that 0.08*D≦d≦0.2*D.

3. The magnet core according to claim 1,
wherein the platelet-shaped particles of a magnetic alloy comprise the alloy composition M_{α}Y_{β}Z_{γ},
wherein M is at least one element selected from the group consisting of Fe, Ni and Co,
wherein Y is at least one element selected from the group consisting of B, C and P,
wherein Z is at least one element selected from the group consisting of Si, Al and Ge, and
wherein α, β and γ are specified in atomic percent and meet the following conditions: 60≦α≦85; 5≦β≦20; 0≦γ≦20,
wherein up to 10 atomic percent of the M component may be replaced by at least one element selected from the group consisting of Ti, V, Cr, Mn, Cu, Zr, Nb, Mo, Ta, and W, and
wherein up to 10 atomic percent of the (Y+Z) component may be replaced by at least one element selected from the group consisting of In, Sn, Sb and Pb.

4. The magnet core according to claim 1,
wherein the magnet core has a DC preloadability B₀ of B₀≧0.24 T at a DC superposition permeability Δμ of 80% of the starting superposition permeability of Δμ₀.

5. The magnet core according to claim 1,
wherein the platelet-shaped particles have an aspect ratio of at least 2.

6. The magnet core according to claim 1,
wherein the thickness D of the platelet-shaped particles is such that 10 μm≦D≦50 μm.

7. The magnet core according to claim 6,
wherein the thickness D of the platelet-shaped particles is such that 20 μm≦D≦25 μm.

8. The magnet core according to claim 1,
wherein the platelet-shaped particles have an average particle diameter L of approximately 90 μm in a plane parallel to the main surfaces.

9. The magnet core according to claim 1,
wherein the platelet-shaped particles further comprise an electrically insulating coating on at least the main surfaces.

10. The magnet core according to claim 1,
wherein the binder comprises at least one material selected from the group consisting of polyimides, phenolic resins, silicone resins and aqueous solutions of alkali or alkaline earth silicates.

11. An inductive component comprising a magnet core according to claim 1.

12. The inductive component according to claim 11,
wherein the inductive component is a choke for power factor correction.

13. The inductive component according to claim 11,
wherein the inductive component is a storage choke.

14. The inductive component according to claim 11,
wherein the inductive component is a filter choke.

15. The inductive component according to claim 11,
wherein the inductive component is a smoothing choke.

16. A method for the production of a magnet core, comprising:
providing a powder comprising amorphous platelet-shaped particles of a magnetic alloy having an amorphous volume matrix and two main surfaces separated by thickness D;
pressing the powder with a binder to produce a shaped core;
heat treating the shaped core for a duration tₐₙₙₑₐₗ≧5 h at a temperature Tₐₙₙₑₐₗ such that 390° C.≦Tₐₙₙₑₐₗ≦440° C. such that areas having a crystalline structure embedded in the amorphous volume matrix are formed on at least one of the main surfaces of the platelet-shaped particles and extend into the amorphous volume matrix.

17. The method according to claim 16,
wherein the heat treating continues until the areas having a crystalline structure have a thickness d such that 0.04*D≦d≦0.25*D and cover a proportion x of the surface of the platelet-shaped particle such that x≧0.1.

18. The method according to claim 16,
wherein the platelet-shaped particles in the powder comprise a magnetic alloy having the alloy composition M_{α}Y_{β}Z_{γ},
wherein M is at least one element selected from the group consisting of Fe, Ni and Co,
wherein Y is at least one element selected from the group consisting of B, C and P,
wherein Z is at least one element selected from the group consisting of Si, Al and Ge, and
wherein α, β and γ are specified in atomic percent and meet the following conditions: 60≦α≦85; 5≦β≦20; 0≦γ≦20,
wherein up to 10 atomic percent of the M component may be replaced by at least one element selected from the group consisting of Ti, V, Cr, Mn, Cu, Zr, Nb, Mo, Ta and W, and
wherein up to 10 atomic percent of the (Y+Z) component may be replaced by at least one element selected from the group consisting of In, Sn, Sb and Pb.

19. The method according to claim 16,
wherein the providing of the powder comprises:
providing an amorphous strip of the magnetic alloy from a rapid solidification process, wherein the strip has a thickness D such that 10 μm≦D≦50 μm;
pre-embrittling the amorphous strip by heat treating it at a temperature T_{embrittle};
comminuting the amorphous strip to produce the platelet-shaped particles.

20. The method according to claim 18,
wherein the thickness D is such that 20 μm≦D≦25 μm.

21. The method according to claim 19,
wherein the temperature T_{embrittle} is such that 100° C.≦T_{embrittle}≦400° C.

22. The method according to claim 21,
wherein the temperature T_{embrittle} is such that 200° C.≦T_{embrittle}≦400° C.

23. The method according to claim 17,
wherein comminuting the amorphous strip provides an average particle diameter of 90 μm.

24. The method according to claim 17,
wherein the comminuting of the amorphous strip is conducted at a grinding temperature Tₘᵢₗₗ of −196° C.≦Tₘᵢₗₗ≦100° C.

25. The method according to claim 16,
further comprising pickling the platelet-shaped particles in an aqueous or alcoholic solution to apply an electrically insulating coating thereto, and then drying the resulting particles before said pressing of the powder with said binder.

26. The method according to claim 16,
wherein said binder comprises at least one material selected from the group consisting of polyimides, phenolic resins, silicone resins and aqueous solutions of alkali or alkaline earth silicates.

27. The method according to claim 16,
wherein the pressing of the powder with a binder comprises coating platelet-shaped particles with the binder and then pressing them together.

28. The method according to claim 27,
wherein the pressing is carried out at a pressure between 1.5 and 3 GPa.

29. The method according to claim 16,
further comprising stress relaxation heat treating the shaped core for a duration tᵣₑₗₐₓ of approximately one hour at a temperature Tᵣₑₗₐₓ of approximately 400° C. thereby relaxing stresses of the magnet core.

30. The method according to claim 16, further comprising adding
one or more processing additives to the platelet-shaped particles and to the binder before pressing.

31. The method according to claim 16,
wherein the heat treating is carried out in an inert atmosphere.

32. The method according to claim 30, wherein the one or more processing additives comprise a lubricant.
